(19) United States
(12) Patent Application Publication
(10) Pub. No.: US 2019/0273955 A1
(43) Pub. Date: Sep. 5, 2019

(54) METHOD, DEVICE AND TERMINAL APPARATUS FOR SYNTHESIZING VIDEO STREAM OF LIVE STREAMING ROOM

(71) Applicant: GUANGZHOU HUADUO NETWORK TECHNOLOGY CO., LTD., Guangzhou (CN)

(72) Inventors: Meng Yu, Guangzhou (CN); Chuan Yu, Guangzhou (CN); Guangxing Xu, Guangzhou (CN); Hao Wu, Guangzhou (CN); Qinghui Su, Guangzhou (CN); Jinling Lu, Guangzhou (CN); Yexiang Guo, Guangzhou (CN)

(21) Appl. No.: 16/419,022

(22) Filed: May 22, 2019

Related U.S. Application Data
(63) Continuation of application No. PCT/CN2017/105017, filed on Sep. 30, 2017.

(30) Foreign Application Priority Data
Nov. 22, 2016 (CN) 201611049302.3

(51) Int. Cl. H04N 21/234; H04N 21/2187; H04N 21/2665; H04L 29/06

(52) U.S. Cl. CPC H04N 21/23424; H04L 65/608; H04N 21/2665; H04N 21/2187

(57) ABSTRACT

The present invention provides a method for synthesizing a video stream of a live streaming room including the steps of: outputting, in response to an operation instruction of a streamer user for activating multi-source live streaming, pre-protocol information containing feature information of a live streaming room and streamer identity information; configuring a terminal of the streamer user as a server terminal, and receiving a connection request initiated by a second terminal according to the pre-protocol information; receiving, in response to the connection request and after a connection of the streamer user to at least one second terminal is confirmed, a second video stream captured by the second terminal; synthesizing a locally captured first video stream and the second video stream into a third video stream, and uploading the same to a server, so that the server pushes the third video stream to each user in the live streaming room.

### CROSS REFERENCE TO RELATED APPLICATIONS

The present application is a Continuation Application of PCT Application No. PCT/CN2017/105017 filed on Sep. 30, 2017, which claims the benefit of Chinese Patent Application No. 201611049302.3 filed on Nov. 22, 2016. All the above are hereby incorporated by reference.

### TECHNICAL FIELD

The present invention generally relates to network live streaming and, more particularly, relates to a method, device and terminal apparatus for synthesizing video stream of a live streaming room.

### BACKGROUND OF THE INVENTION

With the development of internet technology and intelligent mobile terminal, various kinds of internet products have brought convenience and entertainment to people's work and life. In recent years, various kinds of live platforms for live video streaming have emerged, so as to provide people with real-time social interaction experience. Generally, live platforms include live platforms for mobile terminals and live platforms for PC terminals.

Due to different requirements of the users regarding the live video streaming, the users need to live broadcast the content of a number of mobile terminals simultaneously, or live broadcast the content of a number of PC terminals simultaneously, or live broadcast the content of a mobile terminal and a PC terminal simultaneously. For instance, for a user first live broadcast on a PC terminal wants to transfer live scene to the outdoors temporarily and to live broadcast outdoors via a mobile terminal, the conventional art generally requires the streamer user to set up a new live streaming room to initiate a live outdoor broadcast. The viewers of the primary live streaming room need to enter the new live streaming room, so as to watch the outdoor live streaming of the streamer user. The outdoor live streaming is temporary, when the outdoor live streaming ends, the streamer user returns to the PC terminal to continue the live streaming. The viewers also need to enter the live streaming room of the streamer user again. In view of the foregoing, the operation for the streamer user and the viewers is very complicated and cannot bring good experience to the streamer user and the viewers, which may reduce fame of the live platform and cause potential loss of users.

In view of the foregoing, how to realize the multi-source live broadcast mode which can live broadcast at a number of terminals simultaneously is one of the problems needed to be solved in network video live streaming field. In addition, how to improve the utilization of network bandwidth in the multiple sources live broadcast mode and reduce the pressure of the server of the live platform is also one of the problems to be solved in the art.

### BRIEF SUMMARY OF VARIOUS EMBODIMENTS OF THE INVENTION

One object of the present invention is to provide a method and device for synthesizing video stream of a live streaming room.

Another object of the present invention is to provide a terminal apparatus for synthesizing video stream of a live streaming room.

According to one embodiment of the present invention, a method for synthesizing video stream of a live streaming room includes the steps of:

outputting, in response to an operation instruction of a streamer user for activating multi-source live streaming, pre-protocol information containing feature information of a live streaming room and streamer identity information;

configuring a terminal of the streamer user as a server terminal, and receiving a connection request initiated by a second terminal according to the pre-protocol information;

receiving, in response to the connection request and after a connection of the streamer user to at least one second terminal is confirmed, a second video stream captured by the second terminal; and

synthesizing a locally captured first video stream and the second video stream into a third video stream, and uploading the same to a server, so that the server pushes the third video stream to each user in the live streaming room.

According to one aspect of the present invention, the pre-protocol information is represented in form of a QR code, a feature password, or a URL.

According to one aspect of the present invention, receiving the second video stream and locally capturing the first video stream are performed in parallel with synthesizing the third video stream and uploading the third video stream.

According to one aspect of the present invention, the first video stream, the second video stream and the third video stream each includes image stream and audio stream, the third video stream includes the image stream of at least one of the first video stream and the second video stream, and the third video stream includes the audio stream of at least one of the first video stream and the second video stream.

According to one aspect of the present invention, the second terminal initiates a connection request to the streamer user according to the pre-protocol information, and keeps a persistent connection to the streamer user terminal.

According to another embodiment of the present invention, a device for synthesizing video stream of a live streaming room includes:

an output module, configured to output, in response to an operation instruction of a streamer user for activating multi-source live streaming, pre-protocol information containing feature information of a live streaming room and streamer identity information;

a configuration module, configured to configure a terminal of the streamer user as a server terminal, and receive a connection request initiated by a second terminal according to the pre-protocol information;

a receive module, configured to receive, in response to the connection request and after a connection of the streamer user to at least one second terminal is confirmed, a second video stream captured by the second terminal; and

a synthesis module, configured to synthesize a locally captured first video stream and the second video stream into a third video stream, and upload the same to a server, so that the server pushes the third video stream to each user in the live streaming room.

According to one aspect of the present invention, the pre-protocol information is represented in form of a QR code, a feature password, or a URL.

According to one aspect of the present invention, receiving the second video stream and locally capturing the first video stream are performed in parallel with synthesizing the third video stream and uploading the third video stream.

According to one aspect of the present invention, the first video stream, the second video stream and the third video stream each includes image stream and audio stream, the third video stream includes the image stream of at least one of the first video stream and the second video stream, and the third video stream includes the audio stream of at least one of the first video stream and the second video stream.

According to a yet another embodiment of the present invention, a terminal apparatus includes a processor and a storage, wherein the processor is configured to invoke any step of the method for synthesizing a video stream of a live streaming room stored in the memory in a program form.

Compared with the conventional art, the present invention at least has the following advantages:

Firstly, the streamer terminal is configured as the server terminal, configured to receive the video stream captured by the second terminal and sent to the streamer terminal The streamer terminal synthesizes all the video streams into a video stream pushed to the live streaming room. The video stream received by the viewers of the live streaming room is the same as the video stream of the streamer terminal, to keep the simultaneity of the video stream.

Secondly, the streamer terminal is configured as the server terminal The video stream captured by the second terminal is sent to the streamer terminal directly without passing the server of the live platform. The live platform server receives the video stream uploaded by the streamer terminal and finally been pushed to the live streaming room. The video stream is pushed to each viewer in the live streaming room. There is no need to upload the video stream to the server by a lot of second terminals, which can reduce bandwidth usage and lower a workload of a live platform server.

Thirdly, the video stream pushed to the live streaming room is adapted to various kinds of playback terminals of the live video, such as the PC, the mobile device and the WEB browser. There is no need to adapt different video stream resolution protocols for different terminals, thereby completely improving adaptability.

Other advantages and novel features will be drawn from the following detailed description of preferred embodiments with the attached drawings. The accompanying drawings, which are incorporated in and constitute a part of this specification, illustrate embodiments of the present invention and, together with a general description of the invention given above, and the detailed description of the embodiments given below, serve to explain the principles of the invention:

### BRIEF DESCRIPTION OF THE DRAWINGS

FIG. 1 shows an illustrative flow diagram of a method for synthesizing video stream of a live streaming room according to one embodiment of the present invention;

FIG. 2 shows two illustrative diagrams of two multiple-sources live streaming according to one embodiment of the present invention;

FIG. 3 shows an illustrative diagram according to one embodiment of the present invention, in which the pre-protocol information is represented in the form of a QR code;

FIG. 4 shows an illustrative diagram according to one embodiment of the present invention, in which the pre-protocol information is represented in the form of a feature password;

FIG. 5 shows an illustrative diagram according to the present invention, in which the pre-protocol information is represented in the form of or a URL;

FIG. 6 shows an illustrative diagram of a third video stream, in which two second video streams have been connected; and

FIG. 7 shows an illustrative diagram of a device for synthesizing video stream of a live streaming room according to one embodiment of the present invention.

### DETAILED DESCRIPTION OF THE INVENTION

Example embodiments of the present invention will now be described more fully hereinafter with reference to the accompanying drawings, in which some, but not all embodiments of the invention are shown, and like reference numerals refer to like elements throughout. Indeed, the invention may be embodied in many different forms and should not be construed as limited to the embodiments set forth herein; rather, these embodiments are provided so that this disclosure will satisfy applicable legal requirements.

It should be understood by one skilled in the art that, unless otherwise specified, singular forms of “a”, “an”, “the” can include plural forms. It should be understood that, the wordings “include”, “including”, “comprise”, “comprising” in the description of the present invention refers to features, integers, steps, operations, components and/or assembly. The presence or addition of one or more other features, integers, steps, operations, components, components, assemblies and/or groups thereof are not excluded. It should be understood that, in the description of the present invention, when a component is “connected” or “coupled” to another component, the component can be connected or coupled to another component directly or indirectly. “Connected” or “coupled” in the present invention includes wirelessly connected or wirelessly coupled. Wording “and/or” includes all or any of the units and all combinations of one or more associated listed items.

It should be understood by one skilled in the art that, unless otherwise defined, the terms in the present invention (including technical terms and scientific terms) have same meaning as the general understanding of one of skilled in the art. It should also be understood by one skilled in the art that the terms defined in the general dictionary should be understood as having meanings consistent with the meaning in the context of the prior art. Unless defined specifically in the present invention, it will not be interpreted in an idealized or overly formal meaning.

It should be understood by one skilled in the art, the terms of “terminal” or “terminal device” in the present invention not only includes wireless signal receiver device having only non-transmitting wireless signal receiver, but also includes device that receives and transmits hardware capable of performing two-way communication of receiving and transmitting on a two-way communication link. Such device includes a cellular or other communication device having a single source display or a multi-source display or a cellular or other communication device without a multi-source display; Personal communications service (PCS) which can combine audio, data processing, fax and/or data communication capabilities; Personal digital assistant (PDA) including RF receiver, pager, internet/intranet access, web browser, notepad, calendar and global positioning system (GPS) receiver; conventional laptop and/or palmtop or other device having and/or including a radio frequency receiver. The terms of “terminal” and “terminal apparatus” in the present invention may be portable, transportable, installable in vehicles (aviation, sea and/or land), or suitable for and/or configured to run locally, or operational in any position on earth and/or in the space in the form of distribution. The terms of “terminal” and “terminal apparatus” in the present invention may be communication terminal, internet terminal, music/video player, such as PDA, Mobile Internet Device (MID), and/or mobile phone having music/video playback function. The terms of “terminal” and “terminal apparatus” in the present invention may also be smart TV and set top box.

It should be understood by one skilled in the art the remote network device in the present invention includes, but not limited to, computer, network host, single web server, cloud consisting of multiple network server sets or multiple servers. The cloud consists of a large number of computers or web servers based on cloud computing. Cloud computing is one kind of distributed computing. A super virtual computer is consisted of a group of loosely coupled computers. In one embodiment of the present invention, the remote network device, the terminal apparatus and the WNS server can communicate by any means of communication, including but not limited to, mobile communication based on 3GPP, LTE, WIMAX; computer network communication based on TCP/IP UDP protocol; short-range wireless transmission based on Bluetooth, infrared transmission standard.

It should be understood by one skilled in the art the user interface/operation interface in the present invention generally refers to a display interface that can be used to send control commands to a smart terminal. For instance, the user interface/operation interface can be an option (or a button added by the application) in a set page of the Android system, or an option of a notification bar from the desktop or interactive page, or an option in a page constructed by the active component of the application program. Although some exemplary embodiments of the present invention have been shown in the description, it is understandable to one ordinary skilled in the art that variations of the exemplary embodiments may be made without departing from the spirit and scope of the invention, and the scope of the invention is defined by the claims and their equivalents.

It should be understood by one ordinary skilled in the art that the terms of “application”, “application program”, “application software” and other terms having similar expression have same meaning as known in the art, referring to computer software applicable for electronic operation constructed from a series of computer instructions and related data resources. Unless otherwise specified, the naming itself is not limited by the type and level of programming language, and not limited by the operating system or platform on which it operates. Of course, such concepts are also not limited by any form of terminal

Live streaming room: live streaming room in the present invention has the following meanings. 1) A virtual space or a virtual room created based on a network live platform. A live streaming room is generally created by a streamer terminal and is connected to a number of viewer terminals. In other words, the live streaming room includes a streamer and a number of viewers. The viewer terminals in the virtual space can view the live content of the streamer terminal. At the same time, the user of the streamer terminal and the user of the viewer terminal, the user of the viewer terminal and the user of the viewer terminal can interact with each other via audio, picture, text and virtual gift. 2) Instant messaging platform that aggregates users together in groups, such as video conferencing system. A user enters the group by logging in to the client terminal. A user exists as a group member in the group. A same group includes a number of group members. A user can join or leave the group at will. In the group, the members can interact with each other via text, audio and video.

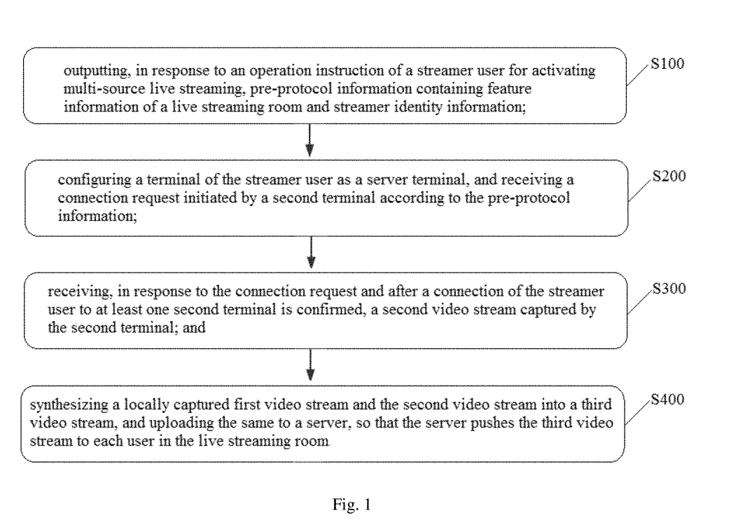

According to a first embodiment of the present invention, as shown in FIG. 1, a method for synthesizing video stream of a live streaming room includes the steps of:

The method of the present invention relies on a functional module or plug-in of live video streaming user terminal. The live video streaming user terminal includes the video live streaming software in the PC terminal and the video live application in the mobile terminal The functional module or plug-in is typically the executable code in the software/application program. In the present invention, there is no particular limitation to the implementation form of the functional module or plug-in.

Step S100: outputting, in response to an operation instruction of a streamer for activating multi-source live streaming, pre-protocol information containing feature information of a live streaming room and streamer identity information;

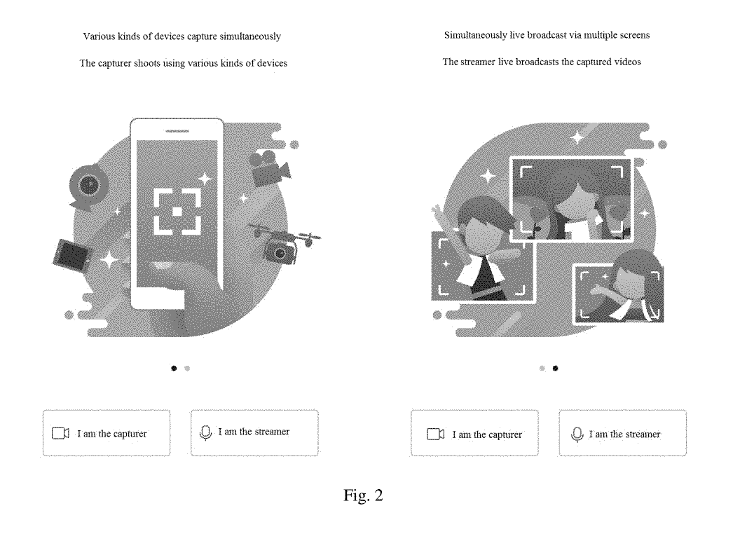

More specifically, FIG. 2 shows two embodiments of the multi-source live streaming: 1) Simultaneously capturing multiple video streams using various kinds of photographic apparatus, and synthesizing the multiple video streams into a video stream to be sent to the live streaming room at the streamer terminal in the name of the streamer. For instance, the streamer initially broadcasts in the PC terminal. Then the streamer intends to transfer live scene temporarily. In this case, the video stream of another scene can be captured via a mobile phone terminal. Then, the video stream is synthesized with the video stream of the PC terminal, so as to realize multi-source live streaming. 2) Capturing the first video stream via a streamer terminal, connecting multiple users and receiving the second video stream captured by the second terminal of the users, and synthesizing the video streams and pushing the synthesized video stream to the live streaming room to realize multi-source live streaming at the streamer terminal The user clicks the button “I am the streamer” shown in FIG. 2, enters the user identify information to login live platform, and initiates a multi-source live streaming as a streamer after configuring the information, such as the title and the cover image, of the live streaming room.

More specifically, the pre-protocol information includes feature information of the live streaming room, the identify information of the streamer. In addition, the pre-protocol information may further include the authorization token or the authentication information to form an exclusive link between the streamer terminal and the second terminal. The authorization token or the authentication information may be encrypted and stored in the pre-protocol information, and may be parsed from the pre-protocol information via an authorized application, so as to obtain the feature information of the live streaming room and the identify information of the streamer. Generally, the pre-protocol information may be defined by each live platform. The pre-protocol information can be obtained only after identifying the form of the pre-protocol information via application authorized by the live platform. The feature of the live streaming room is the channel ID of the live streaming room, to identify the unique live streaming room. The streamer information is the UID of the streamer users to identify the streamer identification of the user.

More specifically, the pre-protocol information is represented in form of a QR code, a feature password, or a URL.

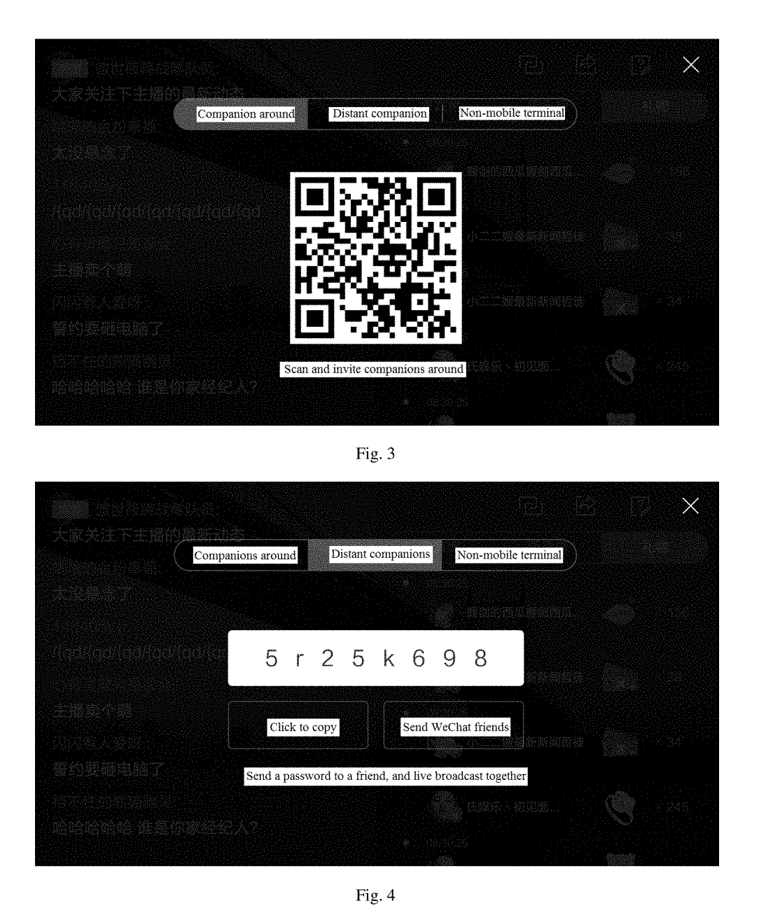

FIG. 3 shows an illustrative diagram in which the pre-protocol information is represented in the form of a QR code. The QR code records data symbol information via black and white graphics including a certain geometric figures having predetermined shapes distributed on a two-dimensional plane in a predetermined fashion. The QR code utilizes the concept of “0” and “1” bit streams that form the basis of the computer's internal logic in code compilation. Representing information, for instance text and value, via a number of geometric shapes corresponding to binary can realize acquiring the information contained in the QR code via scanning the QR code using an image input device or a photoelectric scanning equipment. QR code has multiple commonalities of bar code technology: each code having its own character set; each character occupying a predetermined width; and having certain check function.

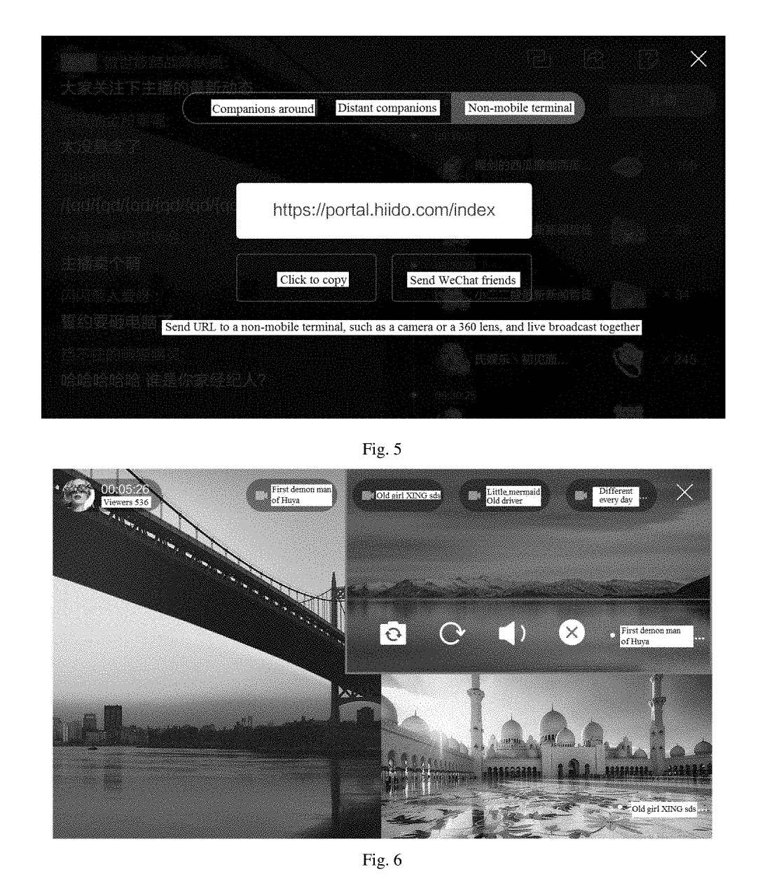

In addition, the pre-protocol information may be represented in the form of a feature password as shown in FIG. 4. The pre-protocol information may be represented in the form of a URL as shown in FIG. 5. No matter what kind of form the pre-protocol information may be represented, the pre-protocol information must be obtained via the applications authorized by the live platform according to the pre-defined protocol.

Step 200: configuring a terminal of the streamer user as a server terminal, and receiving a connection request initiated by a second terminal according to the pre-protocol information;

After the streamer user initiates a multi-source live streaming, the video live streamer terminal configures the streamer terminal to a server to receive the video stream of the second terminal. In order to distinguish from the server of the live platform, in the present embodiment, the streamer terminal is called sever terminal At the same time, the streamer sends the pre-protocol output by the live streamer terminal to other users or terminal devices, so that the second terminal sends the request for connection to the server terminal according to the pre-protocol.

More specifically, after the second terminal sending the request for connection to the streamer terminal according to the pre-protocol, the live platform verifies the pre-protocol information. If the pre-protocol information is verified successfully, the request for connection is identified as a valid connection request. An exclusive communication link is established between the streamer terminal and the second terminal, so as to realize data transmission between the streamer terminal and the second terminal. In this case, the communication link connection is realized in the form of persistent connection between the second terminal and the streamer terminal. Persistent connection is a long-term connection of the client to the server. In the present embodiment, because the streamer terminal is configured as the server terminal, persistent connection means that the live streaming user terminal of the second terminal is connected to the server terminal (i.e. the streamer user terminal) for a long time. Two communication parties that maintain persistent connections can continuously send a number of data packages on one connection. Generally, a server has a timeout limit, i.e. the server will automatically disconnect the connection if the connection is inactive in a certain period of time (no data transmission). Therefore, a user needs to send a heartbeat detection package at preset intervals, to keep the persistent connection. In the present embodiment, when the streamer terminal and the second terminal are in persistent connection, if there is no package sent, the live video user terminal of the second terminal needs to send a heartbeat detection package to the streamer terminal at preset intervals, to keep the persistent connection. Persistent connection is applicable for point-to-point communication. For the video live streaming field, the present invention can reduce bandwidth usage, lowers a workload of a live streaming platform server.

S300: receiving, in response to the connection request and after a connection of the streamer user to at least one second terminal is confirmed, a second video stream captured by the second terminal; and

In response to the connection request, the video live streaming user of the streamer user displays one or more second terminals in persistent connection on the video live streaming interface. Limited by the characteristics of the persistent connection and the size of the video live streaming interface, the number of the second terminals in persistent connection to the streamer terminal is no more than 5. After the streamer user selects one or more second terminals to confirm connection, the second terminal transfers the second video stream to the server terminal. There is no need to send heartbeat detection package. The server terminal, i.e. the streamer terminal, receives the second video stream captured by the second terminal. In addition, the streamer user can cancel receiving the video stream of the second terminal on the operation interface of the streamer terminal at any time. In this case, the second terminal does not send the second video stream to the server terminal After a specified time, the second terminal sends heartbeat detection package to the server terminal again, so as to keep the persistent connection with the server terminal. In addition, the streamer user can disconnect the persistent connection to the second terminal After a specified time from the disconnection, the second terminal sends the heartbeat detection package again to the server terminal. If the server terminal has no feedback, the persistent connection between the second terminal and the server terminal is disconnected.

S400: synthesizing a locally captured first video stream and the second video stream into a third video stream, and uploading the same to a server, so that the server pushes the third video stream to each user in the live streaming room.

After the connection between the streamer user and at least one second terminal is confirmed, the video stream captured by the second terminal is received. At the same time, the locally captured first video stream and the second video stream is synthesized into a third video stream and uploaded the same to the server, so that the server pushes the third video stream to each user in the live streaming room. The first video stream, the second video stream and the third video stream each includes an image stream and an audio stream. The third video stream includes the image stream of at least one of the first video stream and the second video stream. The third video stream further includes the audio stream of at least one of the first video stream and the second video stream. For instance, the streamer terminal receives a second video stream. In this case, the video stream of the streamer terminal includes an image stream and an audio stream of the first video stream, and an image stream and an audio stream of the second video stream. In the synthesis of the third video stream, according to the selection of the streamer user, one of the audio stream of the first video stream and the audio stream of the second video stream is selected, or one of the audio stream of the first video stream and the audio stream of the second video stream is adjusted, so as to do not affect the playback of another audio stream. FIG. 6 shows the third video stream after two second audio streams have been connected.

In the present embodiment, receiving the second video stream and locally capturing the first video stream are performed in parallel with the synthesis of the third video stream and the upload of the third video stream. Parallel work refers to the completion of two or more works having same or different natures at the same time or within the same time interval. Parallel work has 1) time overlap: Adjacent processing is staggered in time, using overlapping parts of the same set of hardware in turn. 2) Resource sharing: Multiple users use the same set of resources in turn in a certain time sequence, so as to improve resource utilization. 3) Duplicate resources: Repeat setting hardware resources, to improve the reliability and performances of the hardware. More specifically, in the embodiment of the present invention, parallel work refers the streamer terminal can synchronously capture the first video stream when receiving the second video stream, synchronously synthesize the captured first video stream and the received second video stream into the third video stream, and synchronously upload the third video stream to the server, so as to ensure the simultaneity and synchronization of the live video stream.

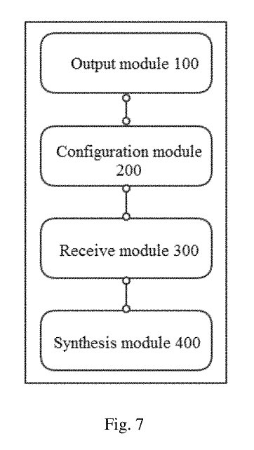

Referring to FIG. 7, one embodiment of the present invention provides a device for synthesizing video stream of a live streaming room includes:

an output module 100, configured to output, in response to an operation instruction of a streamer user for activating multi-source live streaming, pre-protocol information containing feature information of a live streaming room and streamer identity information;

The user clicks the button of “I am the streamer” as shown in FIG. 2, and enters the user identity information of the live platform. The streamer can initiate a multi-source live streaming as a streamer after configuring the title of the live streaming room and the cover image, i.e. trigger an operation command to enable multi-source live streaming. The output module 100 outputs the pre-protocol information, including the live room feature information and the streamer identity information in form of a QR code as shown in FIG. 3, or a feature password as shown in FIG. 4, or a URL as shown in FIG. 5.

a configuration module 200, configured to configure a terminal of the streamer user as a server terminal, and receive a connection request initiated by a second terminal according to the pre-protocol information.

After the streamer user initiates a multi-source live streaming, the configuration module 200 configures the streamer terminal as a server to receive the video stream of the second terminal. In order to distinguish it from the server of the live platform, in the present embodiment, the streamer terminal is called as the server terminal. At the same time, the streamer user sends the pre-protocol information output by the live streaming user terminal to other users/terminal apparatus, so that the second terminals can request a connection to the server terminal according to the pre-protocol information.

a receive module 300, configured to receive, in response to the connection request and after a connection of the streamer user to at least one second terminal is confirmed, a second video stream captured by the second terminal; and

In response to the request for connection, the receive module 300 displays one or more second terminals maintaining the persistent connection status in the video live interface. At the same time, the streamer user determines connection to one or more second terminals. In this case, the second terminal sends the second video stream to the server terminal. There is no need to send heartbeat detection package between the second terminal and the server terminal. The receive module 300 receives the second video stream captured by the second terminal.

a synthesis module 400, configured to synthesize a locally captured first video stream and the second video stream into a third video stream, and uploading the same to a server, so that the server pushes the third video stream to each user in the live streaming room.

After connection between the streamer user and at least one second terminal is confirmed, the video stream captured by the second terminal is received. The synthesis module 400 synthesizes the locally captured first video stream and the second video stream into a third video stream and transfers the same to the server, so that the server pushes the third video stream to each user in the live streaming room. The video stream includes an image stream and an audio stream. The third live streaming video stream includes the image stream of at least one of the first live streaming video stream and the second live streaming video stream, or the image stream synthesized by the first live streaming video stream and the second live streaming video stream. The third live streaming video stream includes the audio stream of at least one of the first live streaming video stream and the second live streaming video stream.

In the present embodiment, receiving the second video stream and locally capturing the first video stream are performed in parallel with synthesizing the third video stream and uploading the third video stream. More specifically, in one embodiment of the present invention, when the receive module 300 receives the second video stream, the first video stream is captured synchronously, the synthesis module 400 synthesizes the captured first video stream and the second video stream into the third video stream synchronously, and the third video stream is uploaded to the server synchronously, so as to ensure the simultaneity and synchronization of the live streaming video stream.

In addition, the present invention also provides a terminal apparatus including a storage and a processor. The storage is configured to store the candidate intermediate data and result data generated in the implementation of the method. The processor is configured to invoke any step of the method for synthesizing a video stream of a live streaming room stored in the memory in a program form.

Compared with the conventional art, the present invention at least has the following advantages:

Firstly, the streamer terminal is configured as the server terminal, configured to receive the video stream captured by the second terminal and sent to the streamer terminal The streamer terminal synthesizes all the video streams into a video stream pushed to the live streaming room. The video stream seen by the viewers of the live streaming room is the same as the video stream of the streamer terminal, so as to keep the simultaneity of the video stream.

Secondly, the streamer terminal is configured as the server terminal The video stream captured by the second terminal is sent to the streamer terminal directly without passing the server of the live platform. The live platform server receives the video stream uploaded by the streamer terminal and finally been pushed to the live streaming room. The video stream is pushed to each viewer in the live streaming room. There is no need to upload the video stream to the server by a lot of second terminals, which can reduce bandwidth usage and lower a workload of a live platform server.

Thirdly, the video stream pushed to the live streaming room is adapted to various kinds of playback terminals of the live video, such as the PC, the mobile device and the WEB browser. There is no need to adapt different video stream resolution protocols for different terminals, thereby completely improving adaptability.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments, it should be appreciated that alternative embodiments without departing from the scope of the appended claims. Although specific terms are employed herein, they are used in a generic and descriptive sense only and not for purposes of limitation.

What is claimed is:

1. A method for synthesizing a video stream of a live streaming room, comprising the steps of:
outputting, in response to an operation instruction of a streamer user for activating multi-source live streaming, pre-protocol information containing feature information of a live streaming room and streamer identity information;
configuring a terminal of the streamer user as a server terminal, and receiving a connection request initiated by a second terminal according to the pre-protocol information;
receiving, in response to the connection request and after a connection of the streamer user to at least one second terminal is confirmed, a second video stream captured by the second terminal; and
synthesizing a locally captured first video stream and the second video stream into a third video stream, and uploading the same to a server, so that the server pushes the third video stream to each user in the live streaming room.

2. The method of claim 1, wherein the pre-protocol information is represented in form of a QR code, a feature password, or a URL.

3. The method of claim 1, wherein receiving the second video stream and locally capturing the first video stream are performed in parallel with synthesizing the third video stream and uploading the third video stream.

4. The method of claim 1, wherein the first video stream, the second video stream and the third video stream each comprises image stream and audio stream, the third video stream comprises the image stream of at least one of the first video stream and the second video stream, and the third video stream comprises the audio stream of at least one of the first video stream and the second video stream.

5. The method of claim 1, wherein the second terminal initiates a connection request to the streamer user terminal according to the pre-protocol information, and keeps a persistent connection to the streamer user terminal.

6. A device for synthesizing video stream of live streaming room, comprising:
a storage storing a plurality of program codes; and
a processor configured to execute the plurality of program codes for:
outputting, in response to an operation instruction of a streamer user for activating multi-source live streaming, pre-protocol information containing feature information of a live streaming room and streamer identity information;
configuring a terminal of the streamer user as a server terminal, and receiving a connection request initiated by a second terminal according to the pre-protocol information;
receiving, in response to the connection request and after a connection of the streamer user to at least one second terminal is confirmed, a second video stream captured by the second terminal; and
synthesizing a locally captured first video stream and the second video stream into a third video stream, and uploading the same to a server, so that the server pushes the third video stream to each user in the live streaming room.

7. The device of claim 6, wherein the pre-protocol information is represented in form of a QR code, a feature password, or a link.

8. The device of claim 6, wherein receiving the second video stream and locally capturing the first video stream are performed in parallel with synthesizing the third video stream and uploading the third video stream.

9. The device of claim 6, wherein the first video stream, the second video stream and the third video stream each comprises image stream and audio stream, the third video stream comprises the image stream of at least one of the first video stream and the second video stream, and the third video stream comprises the audio stream of at least one of the first video stream and the second video stream.

10. A terminal apparatus comprising a processor and a storage, wherein the processor is configured to invoke any step of the method of claim 1 stored in the memory in a program form.

11. A terminal apparatus comprising a processor and a storage, wherein the processor is configured to invoke any step of the method of claim 2 stored in the memory in a program form.

12. A terminal apparatus comprising a processor and a storage, wherein the processor is configured to invoke any step of the method of claim 3 stored in the memory in a program form.

13. A terminal apparatus comprising a processor and a storage, wherein the processor is configured to invoke any step of the method of claim 4 stored in the memory in a program form.

14. A terminal apparatus comprising a processor and a storage, wherein the processor is configured to invoke any step of the method of claim 5 stored in the memory in a program form.
